(19) United States
(12) Patent Application Publication
(10) Pub. No.: US 2014/0361505 A1
(43) Pub. Date: Dec. 11, 2014

(54) KINGPIN ASSEMBLY FOR STEERING AND SUSPENSION LINKAGE ASSEMBLY

(71) Applicant: Caterpillar Inc., Peoria, IL (US)

(72) Inventors: Edward Patrick Ormiston, Champaign, IL (US); David William Holthaus, Monticello, IL (US)

(73) Assignee: Caterpillar Inc., Peoria, IL (US)

(21) Appl. No.: 14/469,988

(22) Filed: Aug. 27, 2014

(51) Int. Cl. B62D 7/18

(52) U.S. Cl. CPC B62D 7/18
USPC 280/93.512

(57) ABSTRACT

A kingpin assembly for pivotally supporting a steering knuckle of a steering linkage assembly is disclosed herein. The kingpin assembly includes a pin and a bearing mount assembly. The pin includes a shoulder disposed between a first tapered portion and a second tapered portion. The first tapered portion is structured and arranged for load bearing and is in engagement with the steering knuckle. The second tapered portion is in reverse taper configuration relative to the first tapered portion, measured axially along the pin. The bearing mount assembly has a first bearing half and a second bearing half. The first and second bearing halves sandwiches the second tapered portion for retention thereof. Each of the first and second bearing halves is in engagement with the steering knuckle.

### TECHNICAL FIELD

The present disclosure relates generally to a steering and suspension linkage assembly. More specifically, the present disclosure relates to a kingpin assembly for the steering and suspension linkage assembly.

### BACKGROUND

Various heavy duty machines, such as industrial vehicles, generally include a kingpin for supporting a steering knuckle and a wheel spindle assembly of a steering system. In a double arm suspension system configuration, the kingpin may be fixedly attached to the steering knuckle by forming a tapered joint, and is rotatably attached to an upper control arm and a lower control arm by forming a ball joint at each ends. Hence, the kingpin facilitates, a pivotal movement of the steering knuckle about the upper control arm and the lower control arm, when steered.

Conventionally, the kingpin is fixedly attached to the steering knuckle by forming the tapered joint. The tapered joint facilitates rotation of the steering knuckle, while supporting a multi-directional and complex loads imparted by wheels of the heavy duty machine. In certain situations, such as an operation of the industrial vehicle on uneven, salient or rugged footing, during an impact event on the suspension system, the load imparted on the steering knuckle often reverses. The reverse load acts to pull the kingpin away from its tapered boss, resulting in failure of the kingpin to maintain the tapered joint. This may further lead to kingpin failure to support the multi-directional loads of the wheel. Therefore, the kingpin is required to be applied with high pull-in force to maintain the tapered joint during reverse loaded conditions. The pull-in force to maintain the tapered joint is achieved via threaded studs, in previously known kingpin designs. However, the threaded studs may require very high assembly torque to be assembled with the kingpin, which may create difficulty in assembling the threaded studs.

United States Patent, U.S. Pat. No. 4,798,394A discloses a tapered kingpin which pivotally attaches a steering knuckle to a front axle of the vehicle. Although, the kingpin maintains a tapered joint within the front axle, the steering knuckle may be subject to failure or shorter life under heavy reverse load conditions.

### SUMMARY OF THE INVENTION

Various aspects of the present disclosure are directed to a kingpin assembly for pivotally supporting a steering knuckle of a steering linkage assembly. The kingpin assembly includes a pin and a bearing mount assembly. The pin includes a first tapered portion, a second tapered portion, and a shoulder disposed between the two tapered portions. The first tapered portion is structured and arranged for load bearing and is in engagement with the steering knuckle. The second tapered portion is in a reverse taper configuration relative to the first tapered portion measured axially along the pin. The shoulder is disposed between the first tapered portion and the second tapered portion measured axially along the pin. Further, the bearing mount assembly includes a first bearing half and a second bearing half. The first bearing half and the second bearing half sandwiches the second tapered portion for retention of the second tapered portion. Each of the first bearing half and the second bearing half is in engagement with the steering knuckle.

### BRIEF DESCRIPTION OF THE DRAWINGS

FIG. 1 is a perspective view of a steering and suspension linkage assembly, illustrating a steering linkage assembly assembled with a double arm suspension system, in accordance with the concepts of the present disclosure;

FIG. 2 is a sectional view of the steering linkage assembly of FIG. 1 with portions removed to illustrate a kingpin assembly therein; and

FIG. 3 is an exploded view of the kingpin assembly of FIG. 2, illustrating the split bearing assembly to retain the kingpin assembly.

### DETAILED DESCRIPTION

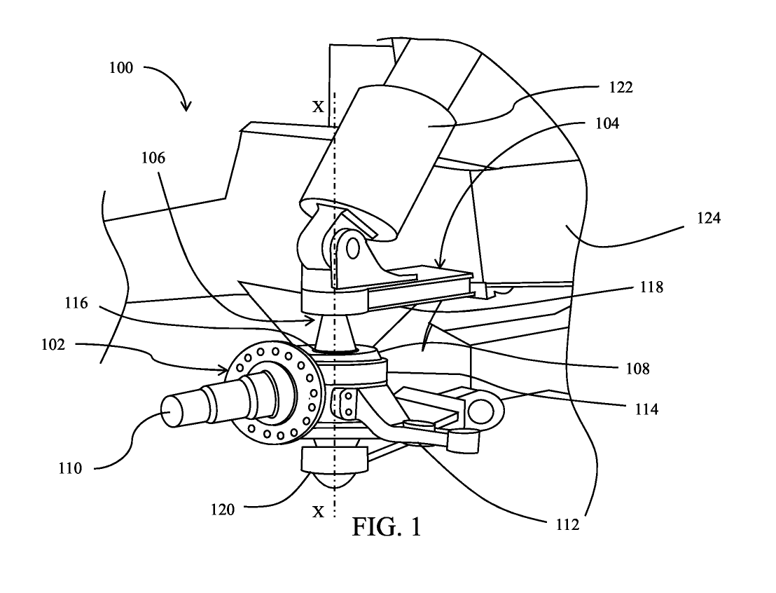

Referring to FIG. 1, there is shown a steering and suspension linkage assembly 100 of a heavy duty machine. The heavy-duty machines may embody a construction machine, a load carrying machine, a forest machine, and the like. The steering and suspension linkage assembly 100 of the heavy duty machine includes a steering linkage assembly 102, a double arm suspension system 104, and a kingpin assembly 106. In a heavy duty machine that employs the double arm suspension system 104, the steering linkage assembly 102 and the double arm suspension system 104 are attached via the kingpin assembly 106.

The steering linkage assembly 102 is provided with a spindle assembly 110, and a wheel assembly (not shown) may be rotatably attached thereto, as is customary. The steering linkage assembly 102 may include a steering knuckle 108, the spindle assembly 110, and a steering arm 112 which, when urged to move by the connected steering linkage (not shown), then the spindle assembly 110 rotates, and redirects the wheel to steer the machine (not shown).

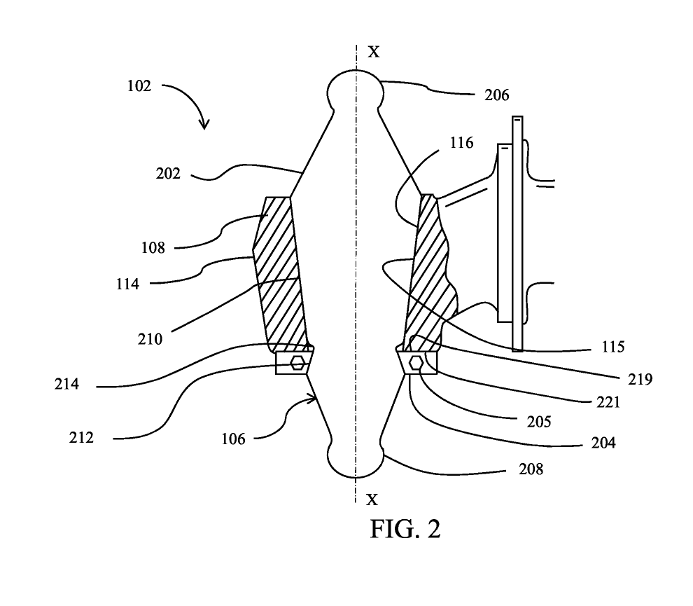

Referring to FIG. 2, the steering knuckle 108 may be cylindrically-shaped having an outer periphery 114, and a through-hole 116 therein. The kingpin assembly 106 includes an axis X-X, along which the steering knuckle 108 is configured to perform a pivotal movement, coincident with the movement of the steering arm 112 (FIG. 1).

Referring back to FIG. 1, the spindle assembly 110 and the steering arm 112, are attached to the outer periphery 114 of the steering knuckle 108. Both the steering arm 112 and the spindle assembly 110 extend radially outwards from the outer periphery 114.

The double arm suspension system 104 may include an upper control arm 118, a lower control arm 120, and a shock absorber 122 attached to the upper control arm 118, to counteract an impact event experienced by the wheel (not shown) as is customary. Each of the upper control arm 118 and the lower control arm 120 are connected to a machine frame 124 at one end. At the other end, the upper control arm 118 and lower control arm 120 are axially aligned with the through-hole 116 of the steering knuckle 108. The upper control arm 118 and the lower control arm 120 are rotatably attached to opposite ends of the steering knuckle 108, via the kingpin assembly 106.

Referring again to FIG. 2, the kingpin assembly 106 is rotatably supported by the upper control arm 118 (FIG. 1) and the lower control arm 120 (FIG. 1). The kingpin assembly 106 may include a pin 202, and a bearing mount assembly 204.

The pin 202 extends inside the through-hole 116 of the steering knuckle 108, while forming a tapered joint with the steering knuckle 108. The pin 202 includes a first hemispherical end 206 and a second hemispherical end 208. The first hemispherical end 206 and the second hemispherical end 208 are respectively rotatably connected to the upper control arm 118 and the lower control arm 120, through ball joints (not shown), for example. The present disclosure contemplates that alternative connection linkages may be used including those which are known to those having ordinary skill in the art.

The pin 202 includes a first tapered portion 210, a second tapered portion 212, and a shoulder 214. The shoulder 214 of the pin 202 is disposed between the first tapered portion 210 and the second tapered portion 212. The first tapered portion 210 of the pin 202 is structured and arranged for load bearing and is in engagement with an inner tapered portion 115 of the steering knuckle 108. The first tapered portion 210 of the pin 202, while being disposed inside the through-hole 116, forms a tapered joint with the inner tapered portion 115 of the steering knuckle 108. The tapered joint enables the pin 202 to support the multi-variant loads exerted by wheels of the heavy duty machine.

The second tapered portion 212 of the pin 202 is not continuous with the first tapered portion 210. Instead, the shoulder 214 is disposed between the first tapered portion 210 and the second tapered portion 212. The second tapered portion 212 is tapered in the opposite direction along the axis X-X compared to the first tapered portion 210. The second tapered portion 212 may be characterized as a reverse-taper configuration relative to the first tapered portion 210, as measured along the kingpin axis X-X. The second tapered portion 212 is positioned outside of the through-hole 116 of the steering knuckle 108, to support the bearing mount assembly 204.

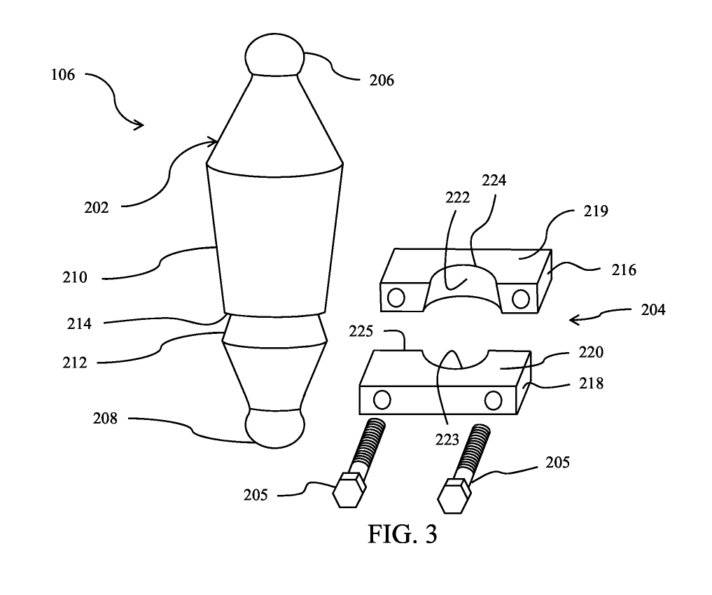

The bearing mount assembly 204 will now be described. As best seen in FIG. 3, the bearing mount assembly 204 respectively includes a first bearing half 216 and a second bearing half 218 which are bolted together by threaded fasteners 205 (FIG. 2), to sandwich the second tapered portion 212 of the pin 202 between these bearing halves 216, 218. As best seen in FIG. 2, each of the first bearing half 216 and the second bearing half 218 are in engagement with the steering knuckle 108. More particularly, a top surface 219, 220 of each of the first bearing half 216 and the second bearing half 218 abuts with a face portion 221 of the steering knuckle 108. In this manner, the pin 202 may be free to rotate within the bearing mount assembly 204. However, it is restrained from movement in the direction toward the first hemispherical end 206 of the pin 202, along the axis X-X.

Moreover, each of the first and second bearing halves 216, 218 include bearing surfaces 222, 223 which engage the second tapered portion 212 of the pin 202. The first and second bearing halves 216, 218 also respectively have an edge portion 224, 225 which contact the shoulder 214 of the pin 202. The pin 202 is also restrained relative to the steering knuckle 108 in the direction toward the second hemispherical end 208 of the pin 202 along the axis X-X, since the edge portions 224, 225 of the bearing mount assembly 204 engage the shoulder 214 of the pin 202 to prevent significant movement of the pin 202 along the axis X-X relative to the steering knuckle 108 coinciding with normal loading conditions. This use of the bearing mount assembly 204 to engage the shoulder 214 of the pin 202 may help set the degree of engagement between the first tapered portion 210 of the pin 202 and the inner tapered portion 115 of the steering knuckle 108. As a result, the friction inherent with the rotating first tapered portion 210 of the pin 202 and the steering knuckle 108 can be kept within an acceptable tolerance through the engagement of the shoulder 214 of the pin 202 with the edge portions 224, 235 of the bearing mount assembly 204.

During assembly, the first bearing half 216 and the second bearing half 218 are bolted together using the fastener 205. In that scenario, the pin 202 is slightly pulled in a direction toward the second hemispherical end 208 of the pin 202 along the axis X-X. This enables a tighter tapered joint being formed between the pin 202 and the steering knuckle 108. In this manner, the pin 202 restrained from movement in the direction toward the first hemispherical end 206 of the pin 202 along the axis X-X, during heavy reverse loaded conditions.

### INDUSTRIAL APPLICABILITY

In operation, the kingpin assembly 106 is positioned between the upper and lower control arms 118, 120 through the first and second hemispherical ends 206, 208 of the pin 202, making ball joint connections with the upper and lower control arms 118, 120. The kingpin assembly 106 transfers the weight of the machine to the wheel(s) through the first tapered portion 210 of the pin 202, as it interfaces with the first tapered portion 210 of the steering knuckle 108.

As the wheel moves over uneven ground, the shock absorber 122 counteracts against the motion of the wheel (not shown). Regardless of the suspension status, the steering may be carried out by the steering arm 112 being rotated, which in turn moves the steering knuckle 108 including the spindle assembly 110, which is attached to the wheel (not shown). However, during extreme machine operation, which is common for construction equipment operation, the double arm suspension system 104 may experience an impact and the resulting impact will reverse the load as the recoil force of the machine urges the machine upwards. The result is the pin 202 attempting to separate from its interface with the first tapered portion 210 of the steering knuckle 108, resulting in failure to maintain the tapered joint. However, since the bearing mount assembly 204 is placed at the second tapered portion 212 (reverse tapered to the first tapered portion 210) of the pin 202, and the top surface 220 of the bearing mount assembly 204 is in contact with the face portion 221 of the steering knuckle 108, the pin 202 is fully retained within the steering knuckle 108. The result is the pin 202 is retained during reverse loading and the steering is insubstantially affected by reverse loading. The steering knuckle 108 is allowed to freely rotate relative along the axis X-X, regardless of the machine loading events.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A kingpin assembly for pivotally supporting a steering knuckle of a steering linkage assembly, the kingpin assembly comprising:
a pin including a first tapered portion structured and arranged for load bearing and in engagement with the steering knuckle, the pin including a second tapered portion, the second tapered portion of the pin being in a reverse taper configuration relative to the first tapered portion thereof, the pin including a shoulder disposed between the first and second tapered portions measured axially along the pin; and
a bearing mount assembly, the bearing mount assembly includes a first bearing half and a second bearing half, the first bearing half and the second bearing half sandwiches the second tapered portion for retention of the second tapered portion, each of the first and second bearing halves being in engagement with the steering knuckle.
